(19) United States
(12) Patent Application Publication
(10) Pub. No.: US 2016/0258265 A1
(43) Pub. Date: Sep. 8, 2016

(54) NOZZLE AND UNDERGROUND COAL GASIFICATION METHOD

(71) Applicant: ENN COAL GASIFICATION MINING CO., LangfangCity, Hebei (CN)

(72) Inventors: Feng CHEN, LangFang City, Hebei (CN); Xia PAN, LangFang City, Hebei (CN)

(21) Appl. No.: 15/029,308

(22) PCT Filed: Apr. 3, 2014
(86) PCT No.: PCT/CN2014/074753

§ 371 Date: Apr. 14, 2016

(30) Foreign Application Priority Data
Oct. 30, 2013 (CN) 201310529895.3

(51) Int. Cl. E21B 43/295; B05B 1/00; B05B 1/30

(52) U.S. Cl. CPC E21B 43/295; B05B 1/3006; B05B 1/005

(57) ABSTRACT

Disclosed is a nozzle including a housing, the housing including a first portion and a second portion, the first portion and the second portion being in fluid communication via a front hole, and a side hole being provided on a side wall of the second portion. The nozzle further includes a sealing assembly able to open and close the front hole and the side hole in a sliding manner in the housing, and a spring provided between the housing and the sealing assembly. Furthermore, an underground coal gasification method using the nozzle is disclosed, which includes the steps of adjusting the injection flow rate and injection pressure of a gasification agent and the pressure of a gas output channel port, and controlling the opening and closing of the front hole and the side hole. The nozzle can optionally alternately or simultaneously open the front hole and the side hole without any manual operation. In the underground coal gasification process, opening the front hole of the nozzle can guide the movement of a gasification working face, opening the side hole can intensify gasification of a coal seam at two sides of a gasification channel, making the two sides of the gasification channel expand more uniformly, increasing the rate of recovery of coal resources.

### FIELD OF THE INVENTION

The invention relates to a nozzle and an underground coal gasification method using the same.

### BACKGROUND OF THE INVENTION

Underground coal gasification is achieved by forming a gasification channel in a coal seam via drilling, injecting a gasification agent into the gasification channel and igniting the coal seam, converting coals into coal gas underground under thermal and chemical actions, and then conveying the coal gas to the ground. During the underground coal gasification, currently retreating gasification or reverse combustion is more popular, that is, a combustion expansion direction is opposite to a gasification agent injection direction in order to avoid roof of cavity caving and pluging the underground gasification channel, or avoid the failure of combusting the coals along the existing channel after a large number of coals is gasified.

A controlled retraction injection point (CRIP) gasification technique previously proposed by the USA is used to regulate and control gas injection points, that is, the gas injection points are moved along a gasification channel and a gasification agent flows axially along the gasification channel, accordingly, the combustion width and height of the gasification channel is out of manual control and merely depends on permeability of the coal seam and diffusion intensity of the gasification agent.

U.S. Pat. No. 4,479,540 discloses a method of underground coal gasification in which a gasification agent is sprayed onto coal walls through a concentric tube nozzle in an underground gasification channel. As shown in the following figures, the nozzle is designed to be rotated horizontally under torsion transferred by a connecting rod to regulate spraying direction of the gasification agent in the gasification channels. However, the nozzle fails to spray the gasification agent onto both two sides and the front, which causes gasification nonuniformity around the underground channels, thereby resulting in low recovery ratio of coal resources.

### DESCRIPTION OF THE INVENTION

It is an objective of the invention to provide a nozzle used for underground coal gasification and able to spray gases or fluids onto the front and the sides alternately or simultaneously, and an underground coal gasification method using the nozzle to inject a gasification agent into a gasification channel.

To achieve the above goal, the invention provides a nozzle comprising a shell including a first portion and a second portion communicating through a front hole, the second portion having side holes on side walls thereof, a seal assembly used for slidably opening and closing the front hole and the side holes in the shell, and a spring disposed between the shell and the seal assembly.

According to the invention, the seal assembly comprises a first sealing element constituting a seal pair together with the front hole, a second sealing element constituting a second seal pair together with the side holes, and a connector connecting the first sealing element and the second sealing element.

According to the invention, the front hole is a round hole, and the first sealing element is a ball or a plate, particularly a rectangular plate.

According to the invention, the side wall of the second portion has two side holes opposite to each other, and the second sealing element is configured to include two arched components arranged oppositely or a hollow cylinder conformally sliding in the shell.

According to the invention, an inner diameter of the first portion is less than that of the second portion.

According to the invention, a separator having a front hole is arranged at a position where the first portion is connected with the second portion.

According to the invention, threads are provided on the side wall of the second portion of the shell.

According to another aspect of the invention, an underground coal gasification method using the above nozzle is provided and the method includes the following steps in order: a: creating a gas inlet channel, a gas outlet channel and a gasification channel connecting the gas inlet channel and the gas outlet channel; b: connecting a first end of a gas injection pipe to the nozzle and feeding the first end of the gas injection pipe into the gasification channel through the gas inlet channel; c: connecting a second end of the gas injection pipe to a gasification agent delivery device; d: injecting a gasification agent into the gasification channel through the gas injection pipe; e: igniting a coal seam where the nozzle is located; and f: regulating the injection flow rate and injection pressure of the gasification agent and the pressure at a mouth of the gas outlet channel to control the opening and closing of the front hole and side holes of the shell.

According to the invention, after the step f is performed, performing step g: moving the nozzle backward by pulling the gas injection pipe to continue to gasify the coals in both the front and the sides of the nozzle; and repeating steps f and g until the nozzle is retreated to a position away from the bottom of the gas inlet channel with a distance from 1 m to 3 m.

According to the invention, before performing the step b, according to ranges of injection pressure of the gasification agent, pressure at the mouth of the gas outlet channel and flow rate of the gasification agent for a target coal seam, selecting a suitable spring inside the nozzle and determining ranges of the injection pressure of the gasification agent, pressure at the mouth of the gas outlet channel and flow rate of the gasification agent under the condition of the front hole in an opened state and the side holes in a closed state, and the ranges of the injection pressure of the gasification agent, pressure at the mouth of the gas outlet channel and flow rate of the gasification agent under the condition of the front hole in a closed state and the side holes in an opened state.

According to the invention, the step f comprises the sub-steps in order: opening the front hole and closing the side holes; closing the front hole and opening the sides holes when the total volume ratio of hydrogen, carbon monoxide and methane in coal gas is decreased by 15% or the volume ratio of hydrogen, carbon monoxide or methane in coal gas is decreased by 20%; and moving the gas injection pipe, and opening the front hole and closing the side holes when the total volume ratio of hydrogen, carbon monoxide and methane in coal gas is decreased by 15% or the volume ratio of hydrogen, carbon monoxide or methane in coal gas is decreased by 20% again.

According to the invention, the step f comprises the following sub-steps in order: opening the front hole and half-opening the side holes simultaneously; and moving the gas injection pipe when the total volume ratio of hydrogen, carbon monoxide and methane in coal gas is decreased by 15% or the volume ratio of hydrogen, carbon monoxide or methane in coal gas is decreased by 20%.

Compared with the prior art, the invention has the following advantageous effects.

The nozzle may be used to open the front hole and the side holes alternately or simultaneously by sliding the seal assembly in the shell, thereby fluids in the shell may be selectively sprayed forward through the front hole in an axial direction of the shell or sprayed outward to the sides of the shell through the side holes. Moreover, the sliding travel of the seal assembly in the shell is determined by controlling the flow rate and pressure of the fluids and thus there is no need to manually open the front hole and the side holes, so that the nozzle can be applied to areas out of the reach of the people, for example, the gasification channel in the underground coal gasification.

The front hole and the side holes are opened alternatively or simultaneously in the process of the underground coal gasification such that opening the front hole may effectively guide the movement of a gasification working face, and opening the side holes may effectively apply reinforced gasification to coal seams at two sides of the gasification channel so as to make gasification more uniformly expand at two sides of the gasification channel and improve the recovery ratio of the coal resources.

### BRIEF DESCRIPTION OF THE DRAWINGS

FIG. 1 is a structural view of a first embodiment of a nozzle of the invention;

FIG. 2 is a structural view of a second embodiment of a nozzle of the invention;

FIG. 3 is a structural view of a third embodiment of a nozzle of the invention; and

FIG. 4 is a view of one embodiment of an underground coal gasification method of the invention.

### DETAILED DESCRIPTION OF ILLUSTRATIVE EMBODIMENTS

The detailed embodiments of the invention are described herein with reference to the following accompanying figures.

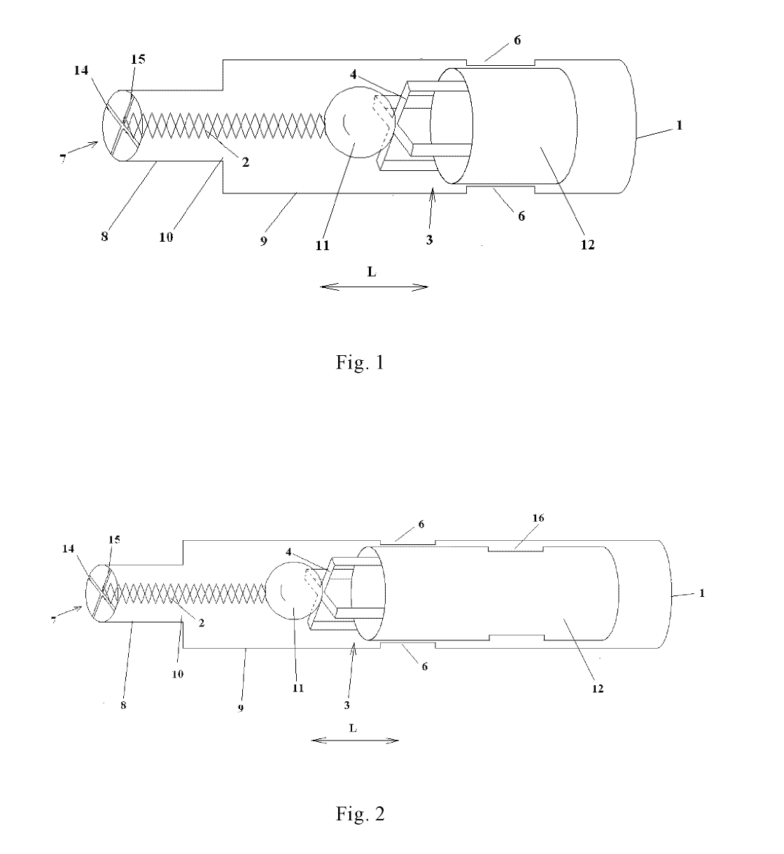

Refer to FIG. 1, the nozzle of an embodiment of the invention comprises a shell 1 including a first portion 8 and a second portion 9 communicating through a front hole 10, and the second portion 9 has side holes 6 at a side wall thereof. Further refer to FIG. 1, the nozzle also comprises a seal assembly 3 used for slidably opening and closing the front hole 10 and the side holes 6 in the shell 1, and a spring 2 disposed between the shell 1 and the seal assembly 3.

More specially, a support 7 is provided at an end of the first portion 8 of the shell 1, wherein the end is far away from the second portion 9, and the spring 2 is connected to the support 7 at one end thereof and the seal assembly 3 at other end thereof. In other words, the spring 2 in a free state passes through the front hole 10 and is positioned between the first portion 8 and the second portion 9. Accordingly, when the fluids push the seal assembly 3 to slide towards the support 7 (also close to the front hole 10), the spring 2 is compressed and deformed; and when the fluids less push the seal assembly 3, the restoring force of the spring 2 pushes the seal assembly 3 to slide away from the support 7. Preferably, the support 7 comprises intersected first and second supporting sheets 14 and 15 having a respective length equal to the diameter of the first portion 8, wherein two ends of the first and second supporting sheets 14 and 15 are fixed to the side wall of the shell 1, respectively, and the spring 2 is fixed to an intersection of the first and second supporting sheets 14 and 15, alternatively, the spring 2 is welded on the intersection.

In the present embodiment, the shell 1 is cylindrical, and the seal assembly 3 comprises a first sealing element 11 constituting a first seal pair together with the front hole 10, a second sealing element 12 constituting a second seal pair together with the side holes 6, and a connector 14 connecting the first sealing element 11 and the second sealing element 12. The first portion 8 of the shell 1 has an inner diameter less than that of the second portion 9, that is to say, the first portion 8 is retracted inward towards the shell 1 relative to the second portion 9 to form the front hole 10 herein. Furthermore, the front hole 10 is a round hole, and the first sealing element 11 is a ball. The ball has a diameter more than or equal to that of the round hole to achieve the formation of the first seal pair by the first sealing element 11 and the front hole 10, i.e. linear seal formed by abutting the ball against the round hole, thereby closing the front hole 10. The ball has a diameter less than that of the second portion 9 of the shell 1 so as to allow the fluids to pass through a gap between the first sealing element 11 and an inner wall of the shell 1, thereby opening the front hole 10.

The connector 4 in the present embodiment is shown as a bracket formed by two intersected door-shaped frames in FIG. 1. Alternatively, the first sealing element 11 is fixed on an intersection of the bracket, and four ends of the bracket are fixed on the second sealing element 12.

Furthermore, in the present embodiment, the side wall of the second portion 9 is provided with two side holes 6 oppositely, and the second sealing element 12 is a hollow cylinder conformally sliding in the shell 1. More specially, the second sealing element 12 is conformed to the inner wall of the shell 1, that is, the hollow cylinder has an outer diameter equal to an inner diameter of the second portion 9 of the shell 1, and an axial length of the hollow cylinder is more than the lengths of the side holes 6 extending axially along the shell 1. The hollow cylinder is conformed to the second portion 9 of the shell 1, so the hollow cylinder shares the same axial direction with the shell 1, namely, the L direction as shown in FIG. 1. Therefore, when the spring 2 is not compressed or is slightly compressed, the side wall of the hollow cylinder covers the side holes 6 fully to constitute the second seal pair by the second sealing element 12 and the side holes 6, i.e. face seal formed by covering the side holes 6 via the side wall of the hollow cylinder, thereby closing the side holes 6 to allow the fluids to flow into the hollow cylinder and then spray them out of the front hole 10. When the front hole 10 is not closed by the first sealing element 11 and the spring 2 is significantly compressed, the hollow cylinder slides to the front hole 10 with the compression of the spring 2 and a rear end face (away from an end face of the front hole 10) of the hollow cylinder moves to the front hole 10 so that the side wall of the hollow cylinder partially covers the side holes 6. The side holes 6 are opened partially such that fluids not entering into the hollow cylinder are sprayed out from the side holes 6 and fluids entering into the hollow cylinder are sprayed out from the front hole 10. When the first sealing element 11 closes the front hole 10, and the side wall of the hollow cylinder separates from the side holes 6 (i.e. the side holes 6 are not covered by the side wall of the hollow cylinder), the side holes 6 are opened fully and the fluids are sprayed out from the side holes 6.

Refer to FIG. 2 showing the second embodiment, the shell 1 is cylindrical and the second sealing element 12 is a hollow cylinder. Via holes 16 are provided on a side wall of the hollow cylinder, and a front-end hole wall of each of the via holes 16 is away from a front-end face of the hollow cylinder (adjacent to the front hole 10) at a distance more than the maximum length of each of the side holes 6 extending along the shell axially. Thus, when the spring 2 is not compressed or slightly compressed, the side wall of the hollow cylinder between the front-end face thereof and the front-end wall holes of the via holes 16 covers the side holes 6 fully to constitute a second seal pair by the second sealing element 12 and the side holes 6, thereby closing the side holes 6 to allow all of the fluids to flow into the hollow cylinder and spray out from the front hole 10. When the first sealing element 11 does not close the front hole 10 and the spring 2 is significantly compressed, the hollow cylinder slides to the front hole 10 with the compression of the spring 2 so that orifices of the via holes 16 of the hollow cylinder partially coincide with those of the side holes 6. Accordingly the side holes 6 are partially opened so as to allow a part of fluids entering into the hollow cylinder to spray out from the side holes 6 and other fluids entering into the hollow cylinder to spray out from the front hole 10. When the first sealing element 11 closes the front hole 10, and the orifices of the via holes 16 of the hollow cylinder coincide with those of the side holes 6 such that the side holes 6 are opened fully and the fluids are only sprayed out from the side holes 6.

Preferably, threads are provided on the side wall of the second portion of the shell 1.

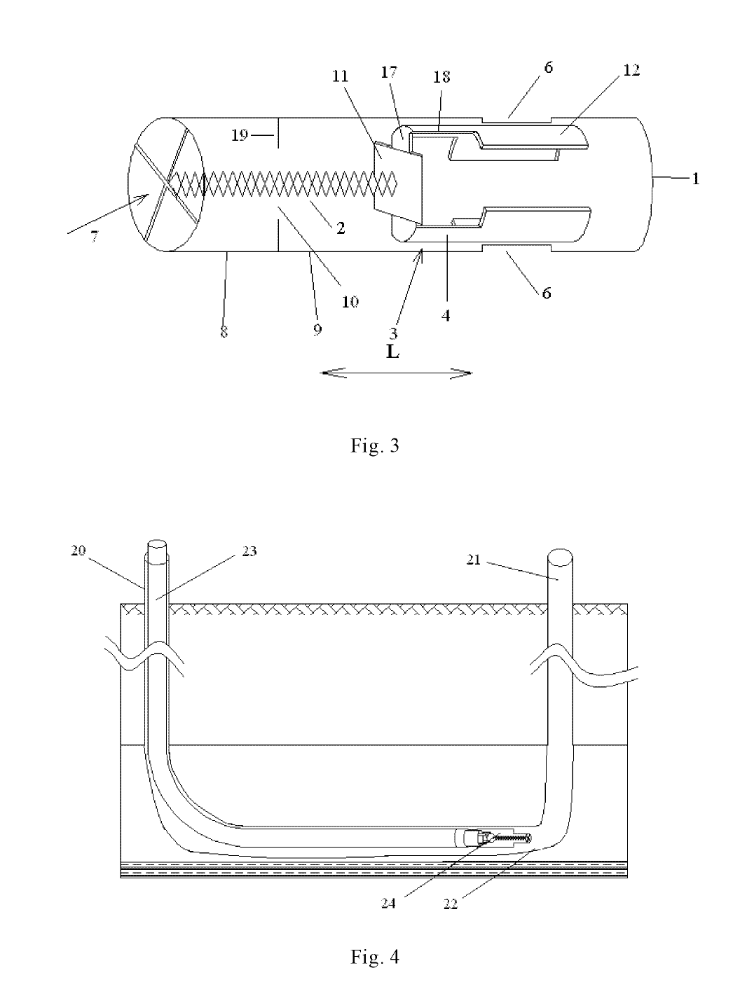

Refer to FIG. 3 showing a third embodiment nozzle of the invention, a separator 19 is arranged at a position where the first and second portions 8 and 9 of the shell 1 of the nozzle are connected and is provided with a front hole 10. The front hole 10 is a round hole and the first sealing element 11 is a rectangular plate. The rectangular plate has a width more than a diameter of the round hole to constitute a first seal pair by the first sealing element 11 and the front hole 10, namely, face seal formed by covering the round hole via the rectangular plate, thereby closing the front hole 10. The second sealing element 12 is configured to include two arched components 13 conformally sliding in the shell and arranged oppositely. The arched components are conformed to an inner wall of the shell 1, that is, surfaces of the arched components slide in adaptation to the inner wall of the shell 1, and the arched components have lengths (the axial length L along the shell 1) which are more than the maximum length of the side hole 6 which extends axially along the shell 1. Thus, when the spring 2 is not compressed or slightly compressed, the side walls of the arched components cover the side holes 6 fully to constitute a second seal pair by the second sealing element 12 and the side holes 6, namely, face seal formed by covering the side holes 6 via the side walls of the arched components, thereby closing the side holes 6 to allow all of the fluids to flow into the hollow cylinder and then spray out from the front hole 10. When the first sealing element 11 does not close the front hole 10 and the spring 2 is compressed significantly, the arched components slide to the front hole 10 with the compression of the spring 2 and rear end faces of the arched components (away from the front wall 10) move to the front hole 10 so that the side walls of the arched components partially cover the side holes 6. The side holes 6 are opened partially so that a part of the fluids sprays out from the side holes 6 and a part of the fluids sprays out from the front hole 10. When the front hole 10 is closed by the first sealing element 11, the side walls of the arched components separate from the side holes 6 (i.e. the side holes 6 are not covered by the side walls of the arched components) and thus the side holes 6 are opened fully so that the fluids are only sprayed out from the side holes 6.

In the present embodiment, the connector 4 is configured to be a door-shaped frame, of which a cross beam 17 is connected to the first sealing element 11 and two supporting beams 18 are connected to the arched components, respectively.

The shapes and sizes of the front hole 10, the side holes 6, the first sealing element 11 and the second sealing element 12 are not limited to the above three embodiments. For example, the front hole 10 is a round hole, and the first sealing element 11 may be a cone of which the maximum round portion has a diameter more than that of the front hole 10 so that the first seal pair is formed by the first sealing element 11 and the front hole 10. It thus just needs realizing the first seal pair formed by the front hole 10 and the first sealing element 11, a gap existing between the first sealing element 11 and the shell 1, the second seal pair formed by the second sealing element 12 and the side holes 6, the side holes 6 opened by the second sealing element 12 partially or fully, and fluids communicated between the second sealing element 12 and the shell 1.

Refer to FIG. 4, an underground coal gasification method using the above nozzle is provided and comprises the following steps in order:

a: creating a gas inlet channel 20, a gas outlet channel 21 and a gasification channel 22 connecting the gas inlet channel 20 and the gas outlet channel 21;

b. connecting a nozzle 24 at a first end of a gas injection pipe 23, and feeding the first end of the gas injection pipe 23 into the gasification channel 22 through the gas inlet channel 20;

c. connecting a second end of the gas injection pipe 23 to a gasification agent delivery device;

d. injecting a gasification agent into the gasification channel 22 through the gas injection pipe 23;

e. igniting a coal seam where the nozzle is located; and

f. regulating the injection flow rate and injection pressure of the gasification agent and the pressure at the mouth of the gas outlet channel to control the opening and closing of the front hole 10 and the side holes 6 to gasify coals in front and at sides of the nozzle.

In the present embodiment, before the step b is performed, according to the ranges of the injection pressure of the gasification agent, the pressure at the mouth of the gas outlet channel and the flow rate of the gasification agent for a target coal seam, a suitable spring inside the nozzle is selected, and the ranges of the injection pressure of the gasification agent, the pressure at the mouth of the gas outlet channel and the flow rate of the gasification agent under the condition of the front hole in an opened state and the side holes in a closed state and the ranges of the injection pressure of the gasification agent, the pressure at the mouth of the gas outlet channel and the flow rate of the gasification agent under the condition of the front hole in a closed state and the side holes in an opened state are determined. Thus, opening or closing the front hole and the side holes can be realized by controlling the injection pressure of the gasification agent, the pressure at the mouth of the gas outlet channel and the flow rate of the gasification agent. In the present embodiment, specially, conditions to open the front hole and close the side holes include the injection pressure of the gasification agent from 0.5 MPa to 0.7 MPa, the pressure at the mouth of the gas outlet channel 21 from 0.05 MPa to 0.08 MPa, and the injection flow rate of the gasification agent less than 2000 Nm³/h. Conditions to close the front hole and open the side holes include the injection pressure of the gasification agent from 0.5 MPa to 0.7 MPa, the pressure at the mouth of the gas outlet channel 21 from 0.05 MPa to 0.08 MPa, and the injection flow rate of the gasification agent more than 3000 Nm³/h.

In the present embodiment, the first end of the gas injection pipe 23 is fed into the gasification channel 22 through the gas outlet channel 20 and then moves to the gasification channel 22 below the gas outlet channel, the coal seam is ignited, a gasification working face moves towards the gas inlet channel from the gas outlet channel in the gasification channel 22, led by pulling the gas injection pipe backward. It should be understood that a direction of the nozzle away from the gas injection pipe connected thereto is defined as the front, and a direction of the nozzle adjacent to the gas injection pipe connected thereto is defined as the rear. In other words, the direction that the gasification agent sprays out from the front hole is defined as a direction from the rear to the front. The sides of the nozzle refer to directions that the nozzle vertically directs to the outside thereof from the side wall.

More specially, the step f comprises the following sub-steps:

f1: regulating the injection pressure of the gasification agent from 0.5 MPa to 0.7 MPa and the pressure at the mouth of the gas outlet channel 21 from 0.05 MPa to 0.08 MPa;

f2: opening the front hole 10 and closing the side holes 6 by regulating the injection flow rate of the gasification agent to be less than 2000 Nm³/h so as to convey the gasification agent to the coal seam at the front of the gasification channel 22 to accelerate the combustion of the coal seam;

f3: collecting coal gas through the gas outlet channel 21;

f4: analyzing compositions of the coal gas; and

f5: closing the front hole 10 and opening the side holes 6 by regulating the injection flow rate of the gasification agent to be more than 3000 Nm³/h if the total volume ratio of hydrogen, carbon monoxide and methane in the coal gas is decreased by 15% or the volume ratio of hydrogen, carbon monoxide or methane in the coal gas is decreased by 20%. Due to the reduction of effective compositions (hydrogen, carbon monoxide and methane) in the coal gas, the substantially complete combustion of the coal seam at the front of the gas injection pipe 23 in the gasification channel 22 can be judged and thus the side holes 6 are opened to inject the gasification agent into the two sides of the gas injection pipe 23, thereby further combusting the coal seam at the two sides of the gasification channel 22 to improve the recovery ratio.

In the present embodiment, after the step f is performed, performing step g: moving the nozzle backward by pulling the gas injection pipe to continue to gasify coals in front and at the sides of the nozzle; and repeating steps f and g until the nozzle is retreated between 1 m and 3 m away from the bottom of the gas inlet channel where the gas inlet channel is connected with the gasification channel. More specially, after the step f5 is performed, the coal gas is collected continually. If the total volume ratio of hydrogen, carbon monoxide and methane in the coal gas is decreased by 15% or the volume ratio of hydrogen, carbon monoxide or methane in coal gas is decreased by 20% again, the gas injection pipe 23 moves backward and the injection flow rate of the gasification agent is regulated to be less than 2000 Nm³/h so as to open the front hole 10 and close the side holes 6. The reduction of the effective compositions of the coal gas again shows the substantively complete combustion of the coal seam at the two sides of the gasification channel 22, and thus the gas injection pipe 23 is moved and the front hole 10 is opened so as to lead the movement of the gasification working face and then the gasification agent sprays out from the front hole 10 at first after the movement. Step f to step g are repeated to fully combust the coal seam around the gasification channel 22. During step f to step g, it is required to keep the injection pressure from 0.5 MPa to 0.7 MPa and regulate the pressure at the mouth of the gas outlet channel 21 from 0.05 MPa to 0.08 MPa.

The principles to use the nozzle as shown in FIG. 1 to open and close the front hole 10 and the side holes 6 in the above steps will be explained in detail.

When the injection pressure of the gasification agent and the pressure at the mouth of the gas outlet channel are regulated from 0.5 MPa to 0.7 MPa and 0.05 MPa to 0.08 MPa, respectively, and the injection flow rate of the gasification agent is regulated to be 2000 Nm³/h, a force of the gasification agent applied to the seal assembly 3 is equal to or slightly more than the pressure of gas between the front hole 10 and the seal assembly 3 in the shell 1 applied to the seal assembly 3, so the seal assembly 3 is stationary or moves slightly towards the front hole 10. At this time, the front hole 10 is not covered by the first sealing element 11 of the seal assembly 3, so the front hole 10 is opened. The second sealing element 12 and the side holes 6 constitute the second seal pair, so the side holes 6 are closed. When the injection pressure keeps from 0.5 MPa to 0.7 MPa and the pressure at the mouth of the gas outlet channel is regulated from 0.05 MPa to 0.08 MPa, and the injection flow rate of the gasification agent is regulated to be more than 3000 Nm³/h, a force of the gasification agent applied to the seal assembly 3 is significantly more than the sum of the pressure of gas between the front hole 10 and the seal assembly 3 in the shell 1 applied to the seal assembly 3 and a restoring force of the spring 2, so the seal assembly 3 significantly moves towards the front hole 10 and compresses the spring 2. At this time, the front hole 10 is covered fully by the first sealing element 11 of the seal assembly 3 and the first sealing element 11 and the front hole 10 form the first seal pair, and thus the front hole 10 is closed. The side holes 6 are not covered by the second sealing element 12 due to the significant movement of the seal assembly 3 and thus the side holes 6 are opened. When the gas injection pipe 23 is moved, and the front hole 10 is opened and the side holes 6 are closed again, the injection flow rate of the gasification agent is regulated to be 2000 Nm³/h, so that a force of the gasification agent applied to the seal assembly 3 is less than the sum of the pressure of gas between the front hole 10 and the seal assembly 3 in the shell 1 applied to the seal assembly 3 and the restoring force of the spring 2. Accordingly, the seal assembly 3 moves away from the front hole 10, and thus the front hole 10 is opened due to its separation from the first sealing element 11, and the side holes 6 are closed because they are covered by the second sealing element 12 again.

Of course, in an alternative embodiment, the step f may comprise the following sub-steps:

The front hole 10 is opened and the side holes 6 are opened partially by regulating the injection pressure of the gasification agent to be from 0.5 MPa to 0.7 MPa, the pressure at the mouth of the gas outlet channel from 0.05 MPa to 0.08 MPa, and the injection flow rate of the gasification agent more than 2300 Nm³/h and less than 2700 Nm³/h. Preferably, the injection flow rate of the gasification agent is regulated to be equal to 2500 Nm³/h to open the front hole 10 and half-open the side holes 6 simultaneously. Thus, the gasification agent can be sprayed out from the front end and sides of the gas injection pipe 23 to uniformly combust the coal seams at the front and sides of the gas injection pipe 23 at the same time.

Then, the coal gas is collected and analyzed. When the total volume ratio of hydrogen, carbon monoxide and methane in the coal gas is decreased by 15%, or the volume ratio of hydrogen, carbon monoxide or methane in coal gas is decreased by 20%, the gas injection pipe 23 is moved. The reduction of the effective compositions in the coal gas shows the substantively complete combustion of the coal seams at the front and sides of the gas injection pipe 23, and then the gas injection pipe 23 is moved to lead the movement of the gasification working face.

The embodiments disclosed above are only preferred embodiments of the invention and they are not used to limit the invention. It will be appreciated by those skilled in the art that various modifications and changes would be made. Any modifications, substitutions, improvements and the like should be covered in the scope of the invention without departing from the principle and spirit of the invention as defined by the appended claims.

1. A nozzle, comprising:
a shell comprising a first portion and a second portion, the first portion and the second portion communicating through a front hole, and the second portion having side holes on a side wall thereof;
a seal assembly configured to slidably open and close the front hole and the side holes in the shell; and
a spring disposed between the shell and the seal assembly.

2. The nozzle of claim 1, wherein the seal assembly comprises a first sealing element constituting a first seal pair together with the front hole, a second sealing element constituting a second seal pair together with the side holes, and a connector connecting the first sealing element and the second sealing element.

3. The nozzle of claim 2, wherein the front hole is a round hole, and the first sealing element is a ball or a plate.

4. The nozzle of claim 2, wherein the second portion has two side holes arranged oppositely on the side wall thereof; and the second sealing element is configured to include two arched components arranged oppositely or a hollow cylinder conformally sliding in the shell.

5. The nozzle of claim 1, wherein the first portion has an inner diameter less than that of the second portion.

6. The nozzle of claim 1, wherein a separator is arranged at a position where the first portion is connected with the second portion, and the separator is provided with the front hole.

7. The nozzle of claim 1, wherein threads are provided on the side wall of the second portion of the shell.

8. An underground coal gasification method using the nozzle of claim 1, comprising the following steps in order:
a. creating a gas inlet channel, a gas outlet channel, and a gasification channel connecting the gas inlet channel and the gas outlet channel;
b. connecting a nozzle at a first end of the gas injection pipe, and feeding the first end of the gas injection pipe into the gasification channel through the gas inlet channel;
c. connecting a second end of the gas injection pipe to a gasification agent delivery device;
d. injecting a gasification agent into the gasification channel through the gas injection pipe;
e. igniting a coal seam where the nozzle is located; and
f. regulating injection flow rate and injection pressure of the gasification agent and pressure at a mouth of the gas outlet channel to control opening and closing of the front hole and the side holes, so as to gasify coals in front and at sides of the nozzle.

9. The underground coal gasification method of claim 8, wherein comprising:
after performing the step f, performing step g: moving the nozzle backward by pulling the gas injection pipe to continue to gasify the coals in front and at the sides of the nozzle; and
repeating steps f and g until the nozzle is retreated to a position away from the bottom of the gas inlet channel with a distance from 1 m to 3 m.

10. The underground coal gasification method of claim 8, wherein comprising:
before performing the step b, according to ranges of injection pressure of the gasification agent, pressure at the mouth of the gas outlet channel and flow rate of the gasification agent for a target coal seam, selecting a suitable spring inside the nozzle and determining ranges of injection pressure of the gasification agent, pressure at the mouth of the gas outlet channel and flow rate of the gasification agent under the condition of the front hole in an opened state and the side holes in a closed state, and ranges of injection pressure of the gasification agent, pressure at the mouth of the gas outlet channel and flow rate of the gasification agent under the condition of the front hole in a closed state and the side holes in an opened state.

11. The underground coal gasification method of claim 8, wherein the step f comprises the following sub-steps in order:
opening the front hole and closing the side holes;
closing the front hole and opening the side holes when the total volume ratio of hydrogen, carbon monoxide and methane in coal gas is decreased by 15%, or a volume ratio of hydrogen, carbon monoxide or methane in coal gas is decreased by 20%; and
moving the gas injection pipe, and opening the front hole and closing the side holes when the total volume ratio of hydrogen, carbon monoxide and methane in coal gas is decreased by 15%, or a volume ratio of hydrogen, carbon monoxide or methane in coal gas is decreased by 20% again.

12. The underground coal gasification method of claim 8, wherein the step f comprises the following sub-steps in order:
opening the front hole and half-opening the side holes simultaneously; and
moving the gas injection pipe when the total volume ratio of hydrogen, carbon monoxide and methane in coal gas is decreased by 15%, or a volume ratio of hydrogen, carbon monoxide or methane in coal gas is decreased by 20%.
